(19) United States
(12) Patent Application Publication
(10) Pub. No.: US 2010/0318576 A1
(43) Pub. Date: Dec. 16, 2010

(54) APPARATUS AND METHOD FOR PROVIDING GOAL PREDICTIVE INTERFACE

(75) Inventor: Yeo-Jin KIM, Suwon-si (KR)

Correspondence Address: North Star Intellectual Property Law, PC, P.O. Box 34688, Washington, DC, 20043, US

(73) Assignee: SAMSUNG ELECTRONICS CO., LTD., Suwon-si (KR)

(21) Appl. No.: 12/727,489

(22) Filed: Mar. 19, 2010

(30) Foreign Application Priority Data
Jun. 10, 2009 (KR) 10-2009-0051675

(51) Int. Cl. G06N 5/02; G06F 3/048; G06F 17/30

(52) U.S. Cl. 707/802; 706/46; 715/812; 707/E17.044

(57) ABSTRACT

A predictive goal interface providing apparatus and a method thereof are provided. The predictive goal interface providing apparatus may recognize a current user context by analyzing data sensed from a user environment condition, may analyze user input data received from the user, may analyze a predictive goal based on the recognized current user context, and may provide a predictive goal interface based on the analyzed predictive goal.

### CROSS-REFERENCE TO RELATED APPLICATION

This application claims the benefit under 35 U.S.C. §119(a) of a Korean Patent Application No. 10-2009-0051675, filed on Jun. 10, 2009, in the Korean Intellectual Property Office, the entire disclosure of which is incorporated herein by reference for all purposes.

### BACKGROUND

1. Field

The following description relates to an apparatus and a method of providing a predictive goal interface, and more particularly, to an apparatus and a method of predicting a goal desired by a user and providing a predictive goal interface.

2. Description of Related Art

As information communication technologies have developed, there has been a trend towards the merging of various functions into a single device. As various functions are added to a device, the number of buttons increases in the device, a complexity of a structure of a user interface increases due to a more complex menu structure, and the time expended searching through a hierarchical menu to get to a final goal or desired menu choice, increases.

Generally, user interfaces are static, that is, they are designed ahead of time and added to a device before reaching the end user. Thus, designers typically must anticipate, in advance, the needs of the interface user. If it is desired to add a new interface element to the device, significant redesign must take place in either software, hardware, or a combination thereof, to implement the reconfigured interface or the new interface.

In addition, there is difficulty in predicting a result occurring based on a combination of selections with respect to commands for various functions. Accordingly, it is difficult to predict that the user will fail to get to a final goal until the user arrives at an end node, even when the user takes a wrong route.

### SUMMARY

In one general aspect, there is provide an apparatus of providing a predictive goal interface, the apparatus including a context recognizing unit to analyze data sensed from one or more user environment conditions, to analyze user input data received from a user, and to recognize a current user context, a goal predicting unit to analyze a predictive goal based on the recognized current user context, to predict a predictive goal of the user, and to provide the predictive goal, and an output unit to provide a predictive goal interface and to output predictive goal.

The apparatus may further including an interface database to store and maintain interface data for constructing the predictive goal, wherein the goal predicting unit analyzes the sensed data and the user input data, and analyzes one or more predictive goals that are retrievable from the stored interface data.

The apparatus may further include a user model database to store and maintain user model data including profile information of the user, preference of the user, and user pattern information, wherein the goal predicting unit analyzes the predictive goal by analyzing at least one of the profile information, the preference information, and the user pattern information.

The goal predicting unit may update the user model data based on feedback information of the user, with respect to the analyzed predictive goal.

The goal predicting unit may provide the predictive goal when a confidence level of the predictive goal is greater than or equal to a threshold, the confidence level being based on the recognized current user context, and the output unit may output the predictive goal interface including the predictive goal corresponding to the predictive goal provided by the goal predicting unit.

The goal predicting unit may predict a menu which the user intends to select in a hierarchical menu structure, based on the recognized current user context, and the predictive goal interface may include a hierarchical menu interface to provide the predictive goal list.

The goal predicting unit may predict the predictive goal including a result of a combination of commands capable of being combined, based on the recognized current user context, and the predictive goal interface includes a result interface to provide the result of the combination of commands.

The sensed data may include hardware data collected through at least one of a location identification sensor, a proximity identification sensor, a radio frequency identification (RFID) tag sensor, a motion sensor, a sound sensor, a vision sensor, a touch sensor, a temperature sensor, a humidity sensor, a light sensor, a pressure sensor, a gravity sensor, an acceleration sensor, and a bio-sensor.

The sensed data may include software data collected through at least one of an electronic calendar application, a scheduler application, an e-mail management application, a message management application, a communication application, a social network application, and a web site management application.

The user input data may be data received through at least one of a text input means, a graphic user interface (GUI), and a touch screen.

The user input data may be data received through an input means for at least one of voice recognition, facial expression recognition, emotion recognition, gesture recognition, motion recognition, posture recognition, and multimodal recognition.

The apparatus may further include a knowledge model database to store and maintain a knowledge model with respect to at least one domain knowledge, and an intent model database to store and maintain an intent model that contains the user intent to use the interface.

The user intents may be recognizable from the user context using at least one of search, logical inference, and pattern recognition.

The goal predicting unit may predict the user goal using the knowledge model or the intent model, based on the recognized current user context.

In another aspect, provided is a method of providing a predictive goal interface, the method including recognizing a current user context by analyzing data sensed from a user environment condition and analyzing user input data received from the user, analyzing a predictive goal based on the recognized current user context, and providing a predictive goal interface including the analyzed predictive goal.

The analyzing of the predictive goal may include analyzing the sensed data and the user input data, and analyzing the predictive goal that is retrievable from interface data stored in an interface database.

The predicting goal may analyze at least one of profile information of the user, preference of the user, and user pattern information, which are stored in the user model database.

The providing the predictive goal may further include providing the predictive goal when a confidence level of the predictive goal is greater than or equal to a threshold, the confidence level being based on the recognized current user context, and the method may further include outputting the predictive goal interface including the provided predictive goal.

In another aspect, provided is a computer readable storage medium storing a program to implement a method of providing a predictive goal interface, including instructions to cause a computer to recognize a current user context by analyzing data sensed from a user environment condition and analyzing user input data received from the user, analyze a predictive goal based on the recognized current user context, and provide a predictive goal interface including the analyzed predictive goal.

Other features and aspects will be apparent from the following detailed description, the drawings, and the claims.

### BRIEF DESCRIPTION OF THE DRAWINGS

FIG. 1 is a diagram illustrating an example predictive goal interface providing apparatus.

FIG. 2 is a diagram illustrating an example process of providing a predictive goal interface through a predictive goal interface providing apparatus.

FIG. 3 is a diagram illustrating another example process of providing a predictive goal interface through a predictive goal interface providing apparatus.

FIG. 4 is a diagram illustrating another example process of providing a predictive goal interface through a predictive goal interface providing apparatus.

FIG. 5 is a flowchart illustrating an example method of providing a predictive goal interface.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

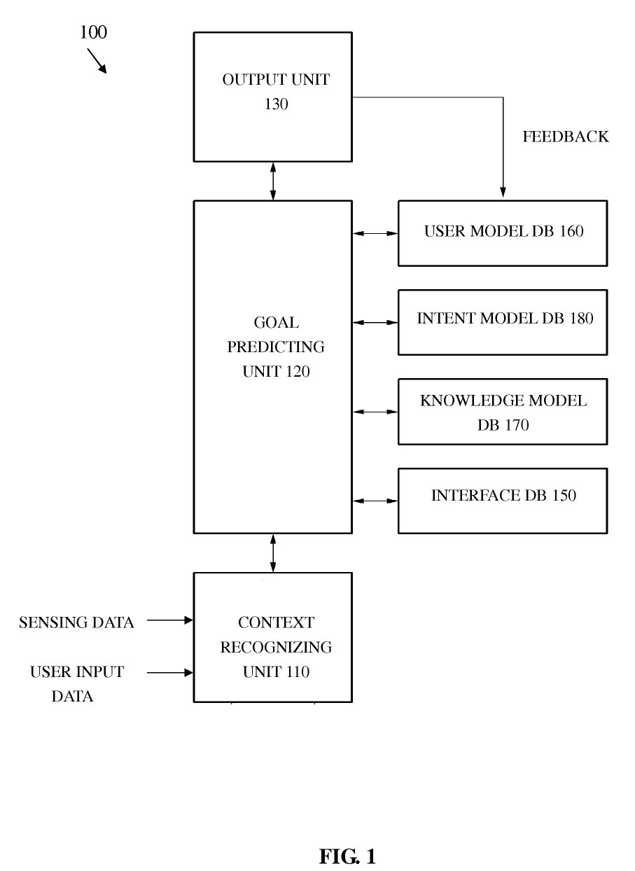

FIG. 1 illustrates an example predictive goal interface providing apparatus 100.

Referring to FIG. 1, the predictive goal interface providing apparatus 100 includes a context recognizing unit 110, a goal predicting unit 120, and an output unit 130.

The context recognizing unit 110 recognizes a current user context by analyzing data sensed from a user environment condition and/or analyzing user input data received from a user.

The sensed data may include hardware data collected through at least one of a location identification sensor, a proximity identification sensor, a radio frequency identification (RFID) tag identification sensor, a motion sensor, a sound sensor, a vision sensor, a touch sensor, a temperature sensor, a humidity sensor, a light sensor, a pressure sensor, a gravity sensor, an acceleration sensor, a bio-sensor, and the like. As described, the sensed data may be data collected from a physical environment.

The sensed data may also include software data collected through at least one of an electronic calendar application, a scheduler application, an e-mail management application, a message management application, a communication application, a social network application, a web site management application, and the like.

The user input data may be data received through at least one of a text input means, a graphic user interface (GUI), a touch screen, and the like. The user input data may be received through an input means for voice recognition, facial expression recognition, emotion recognition, gesture recognition, motion recognition, posture recognition, multimodal recognition, and the like.

The goal predicting unit 120 analyzes a predictive goal based on the recognized current user context. For example, the goal predicting unit 120 may analyze the sensed data and/or the user input data and predict a goal.

For example, the goal predicting unit 120 may predict the menu which the user intends to select in a hierarchical menu structure, based on the recognized current user context. The predictive goal interface may include a hierarchical menu interface with respect to the predictive goal list.

Also, the goal predicting unit 120 may analyze a predictive goal including a result of a combination of commands capable of being combined, based on the recognized current user context. The predictive goal interface may include a result interface corresponding to the result of the combination of commands.

The output unit 130 provides the predictive goal interface, based on the analyzed predictive goal.

The goal predicting unit 120 may output the predictive goal. For example, the goal predicting unit 120 may output the goal when a confidence level of the predictive goal is greater than a threshold level or equal to a threshold level. The output unit 130 may provide the predictive goal interface corresponding to the outputted predictive goal. For example, the output unit may provide a display of the predictive goal interface to a user.

The predictive goal interface providing apparatus 100 may include an interface database 150 and/or a user model database 160.

The interface database 150 may store and maintain interface data for constructing the predictive goal and the predictive goal interface. For example, the interface database 150 may include one or more predictive goals that may be retrieved by the goal predicting unit 120, and compared to the sensed data and/or the user input data. The user model database 160 may store and maintain user model data including a profile information of the user, preference of the user, and/or user pattern information. The sensed data and/or the user input data may be compared to the data stored in the interface database 150 to determine a predictive goal of a user.

The interface data may be data with respect to contents or a menu that are an objective goal of the user, and the user model is a model used for providing a result of a predictive goal individualized for the user. The interface data may include data recorded after constructing a user's individual information or data extracted from data accumulated while the user uses a corresponding device.

In some embodiments, the interface database 150 and/or the user model database 160 may not be included in the predictive goal interface providing apparatus 100. In some embodiments, the interface database 150 and/or the user mode database 160 may be included in a system existing externally from the predictive goal interface providing apparatus 100.

Also, the goal predicting unit 120 may analyze the sensed data and/or the user input data, and may analyze a predictive goal that is retrievable from the interface data stored in the interface database 150. The goal predicting unit 120 may analyze at least one of the profile information, the preference information, and/or the user pattern information included in the user model data stored in the user model database 160. The goal predicting unit 120 may update the user model data based on feedback information of the user with respect to the analyzed predictive goal.

The predictive goal interface providing apparatus 100 may include a knowledge database 170 and/or an intent model database 180.

The knowledge database 170 may store and maintain a knowledge model with respect to at least one domain knowledge, and the intent model database 180 may store and maintain an intent model containing the user's intentions to use the interface. The intentions may be recognizable from the user context using at least one of, for example, search, logical inference, pattern recognition, and the like.

The goal predicting unit 120 may analyze the predictive goal through the knowledge model or the intent model, based on the recognized current user context.

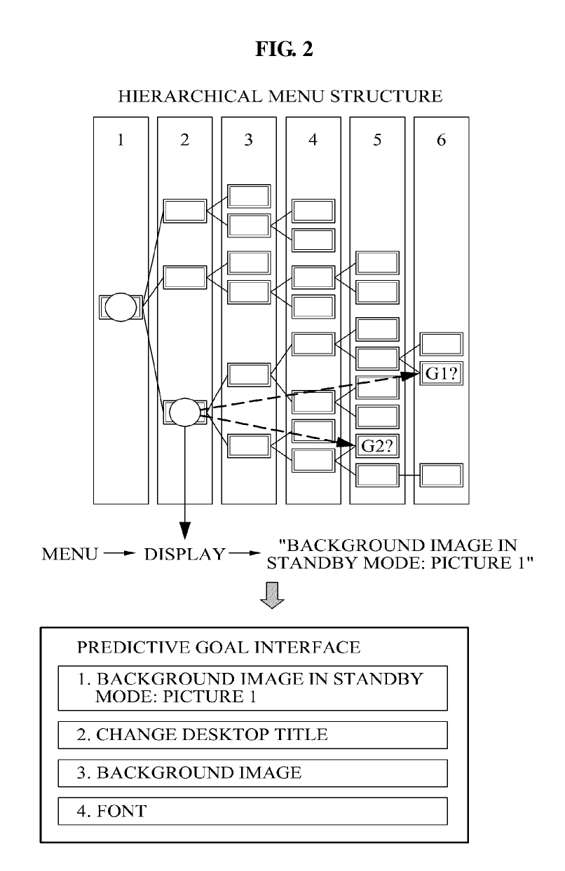

FIG. 2 illustrates an exemplary process of providing a predictive goal interface through a predictive goal interface providing apparatus.

In the conventional art, if a user intends to change, for example, a background image of a portable terminal device into a picture just taken, for example, picture 1, the user may change the background image through a process of selecting the menu option → display option → background image in standby mode option → selecting a picture (picture 1) based on a conventional menu providing scheme.

According to an exemplary embodiment, the predictive goal interface providing apparatus 100 may analyze a predictive goal based on a recognized current user context or intent of the user, and the predictive goal interface providing apparatus 100 may provide the predictive goal interface based on the analyzed predictive goal.

For example, the predictive goal interface providing apparatus 100 may analyze the predictive goal including a predictive goal list with respect to a hierarchical menu structure, based on the recognized current user context, and may provide the predictive goal interface based on the analyzed predictive goal.

As illustrated in FIG. 2, the predictive goal interface may include a hierarchical menu interface with respect to the predictive goal list.

The predictive goal interface providing apparatus 100 may recognize the current user context from data sensed from a user environment condition where the user takes a picture and from user input data, for an example, a process of menu → display → etc., which is inputted from the user for selecting a menu.

For example, based upon the sensed data and/or the user input data, the predictive goal interface providing apparatus 100 may analyze a goal, G1, to change the background image into the picture 1. The predictive goal interface providing apparatus 100 may analyze a predictive goal, G2, to change a font in the background image. The predictive goal interface providing apparatus 100 may provide the predictive goal interface including a predictive goal list being capable of changing of the background image in the standby mode into the picture 1 and/or changing of the font in the background image.

The user may be provided with a goal list that is predicted to be a user's goal through the predictive goal interface providing apparatus 100, according to example embodiments, as the user selects a menu in a hierarchical menu.

Also, the predictive goal interface providing apparatus 100 may predict and provide a probable goal of the user at a current point in time, thereby shortening a hierarchical selection process of the user.

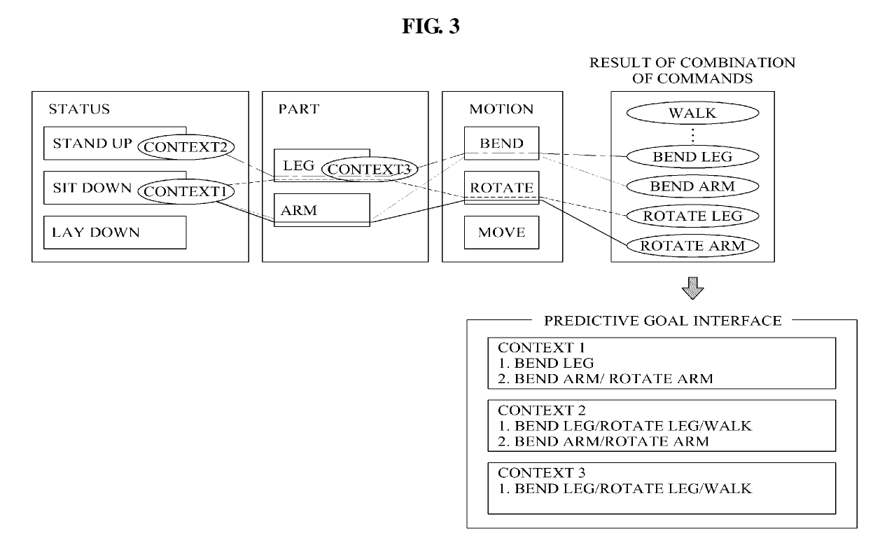

FIG. 3 illustrates another exemplary process of providing a predictive goal interface through a predictive goal interface providing apparatus.

The goal predictive interface providing apparatus 100, according to an exemplary embodiment, may be applicable when various results are derived according to a dynamic combination of selections.

The predictive goal interface providing apparatus 100 may analyze a probable predictive goal from a recognized current user context or user intent, and the predictive goal interface providing apparatus 100 may provide the predictive goal interface based on the analyzed predictive goal.

Also, depending on embodiments, the predictive goal interface providing apparatus 100 may analyze a predictive goal including a result of a combination of commands capable of being combined based on the recognized current user context. In this case, the predictive goal interface may include a result interface corresponding to the combination result.

The predictive goal interface apparatus of FIG. 3 may be applicable to an apparatus, for example, a robot where various combination results are generated according to a combination of commands selected by the user. As described for exemplary purposes, FIG. 3 provides an example of the predictive goal interface apparatus that is implemented with a robot. However, the predictive goal interface apparatus is not limited to a robot, and may be used for any desired purpose.

Referring to FIG. 3, a user may desire to rotate a leg of a robot to move an object behind the robot. The recognized current user context where a robot sits down, is context 1. The predictive goal interface providing apparatus 100 may analyze a predictive goal, for example, ‘bend leg’, ‘bend arm’, and ‘rotate arm’, that is a result of a combination of commands capable of being combined based on the context 1. The predictive goal interface providing apparatus 100 may provide a predictive goal interface including a result interface (1.bend leg and 2.bend arm/rotate arm) corresponding to the combination result.

A user may recognize that ‘bend leg’ is not available from the predictive goal interface based on the context 1, and provided through the predictive goal interface providing apparatus 100. The user may change the context 1 into context 2. The predictive goal interface providing apparatus 100 may analyze a predictive goal, for example, ‘bend leg’, ‘rotate leg’, ‘walk, bend arm’, and ‘rotate arm’, that is a result of a combination of commands capable of being combined based on the context 2. The predictive goal interface providing apparatus 100 may provide a predictive goal interface including a result interface corresponding to the combination result (bend leg/rotate leg/walk and 2.bend arm/rotate arm).

A user may select the ‘leg’ of the robot as a part to be operated, for example, as illustrated in context 3. The predictive goal interface providing apparatus 100 may analyze a predictive goal, for example, ‘bend leg’, ‘rotate leg’, and ‘walk’, which is a result of a combination of commands capable of being combined based on the context 3. The predictive goal interface providing apparatus 100 may provide a predictive goal interface including a result interface corresponding to the combination result (1.bend leg/rotate leg/walk).

The predictive goal interface providing apparatus 100 may predict a result of a series of selections selected by the user and may provide the predicted results. Accordingly, the predictive goal interface providing apparatus 100 may previously provide the predicted result at a current point in time, thereby performing as a guide. The predictive goal interface providing apparatus 100 may enable the user to make a selection, and display a narrowed range of the predictive goal, by recognizing a current context and/or a user intent.

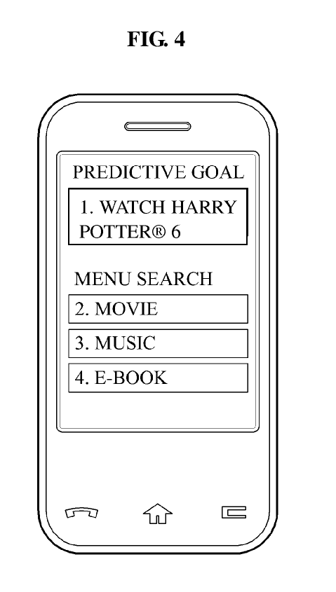

FIG. 4 illustrates another exemplary process of providing a predictive goal interface through a predictive goal interface providing apparatus.

The predictive goal interface providing apparatus 100, according to an exemplary embodiment, may analyze a probable predictive goal from a recognized current user context or user intent, and may provide a predictive goal interface based on the analyzed predictive goal.

Referring to FIG. 4, when a user selects the menu for contents, for example, Harry Potter® 6, manufactured by Time Warner Entertainment Company, L.P., New York, N.Y., the predictive goal interface providing apparatus 100 may recognize the current user context that is analyzed based on the user input data.

Depending on embodiments, the predictive goal interface providing apparatus 100 may analyze a predictive goal (1. watching Harry Potter® 6) based on the recognized current user context, and may provide a predictive goal interface (2. movie, 3. music, and 4. e-book) corresponding to contents or a service that are connectable based on the analyzed predictive goal (1. watching Harry Potter® 6).

The predictive goal interface providing apparatus 100 may output the predictive goal or may provide the predictive goal interface, when a confidence level of the predictive goal (1. watching Harry Potter® 6) is greater than or equal to a threshold level. The predictive goal interface providing apparatus 100 may not output the predictive goal or provide the predictive goal interface, when the confidence level of the predictive goal is below a threshold level.

The predictive goal interface providing apparatus 100, according to an exemplary embodiment, may recognize a user context and user intent, and may predict and provide a detailed goal to a user.

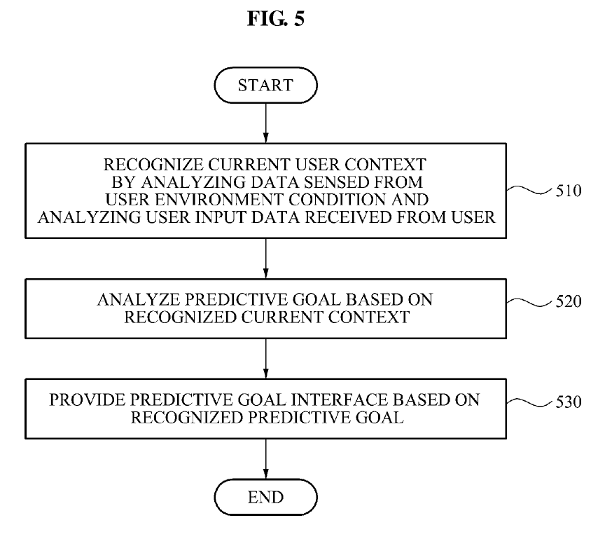

FIG. 5 is a flowchart illustrating an exemplary method of providing a predictive goal interface.

Referring to FIG. 5, the exemplary predictive goal interface providing method may recognize a current user context by analyzing data sensed from a user environment condition and analyzing user input data received from the user in 510.

The predictive goal interface providing method may analyze a predictive goal based on the recognized current user context in 520.

A predictive goal may be retrieved from interface data stored in an interface database. The predictive goal may be determined by analyzing the sensed data and the user input data in 520.

The predictive goal may be analyzed by analyzing at least one of a profile information of the user, a preference of the user, and a user pattern information included in user model data, stored in a user model database, in 520.

The predictive goal interface providing method may provide a predictive goal interface based on the analyzed predictive goal, in 530.

The predictive goal may be outputted when it is determined that a confidence level of the predictive goal based on the recognized current user context is greater than or equal to a threshold level, in 520. The predictive goal interface corresponding to the outputted predictive goal may then be provided in 530.

The method described above, including the predictive goal interface providing method according to the above-described example embodiments, may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. In addition, a computer-readable storage medium may be distributed among computer systems connected through a network and computer-readable codes or program instructions may be stored and executed in a decentralized manner.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing a predictive goal interface, the apparatus comprising:
a context recognizing unit configured to analyze data sensed from one or more user environment conditions, to analyze user input data received from a user, and to recognize a current user context;
a goal predicting unit configured to analyze a predictive goal based on the recognized current user context, to predict a predictive goal of the user, and to provide the predictive goal; and
an output unit configured to provide a predictive goal interface and to output predictive goal.

2. The apparatus of claim 1, further comprising:
an interface database configured to store and maintain interface data for constructing the predictive goal,
wherein the goal predicting unit is further configured to analyze the sensed data and the user input data, and analyzes one or more predictive goals that are retrievable from the stored interface data.

3. The apparatus of claim 1, further comprising:
a user model database configured to store and maintain user model data comprising profile information of the user, preference of the user, and user pattern information,
wherein the goal predicting unit is further configured to analyze the predictive goal by analyzing at least one of the profile information, the preference information, and the user pattern information.

4. The apparatus of claim 3, wherein the goal predicting unit is further configured to update the user model data based on feedback information of the user, with respect to the analyzed predictive goal.

5. The apparatus of claim 1, wherein:
the goal predicting unit is further configured to provide the predictive goal when a confidence level of the predictive goal is greater than or equal to a threshold, the confidence level being based on the recognized current user context; and
the output unit is further configured to output the predictive goal interface comprising the predictive goal corresponding to the predictive goal provided by the goal predicting unit.

6. The apparatus of claim 1, wherein:
the goal predicting unit is further configured to predict a menu which the user intends to select in a hierarchical menu structure, based on the recognized current user context; and
the predictive goal interface comprises a hierarchical menu interface to provide the predictive goal list.

7. The apparatus of claim 1, wherein: the goal predicting unit is further configured to predict the predictive goal comprising a result of a combination of commands capable of being combined, based on the recognized current user context; and
the predictive goal interface comprises a result interface to provide the result of the combination of commands.

8. The apparatus of claim 1, wherein the sensed data comprises hardware data collected through at least one of a location identification sensor, a proximity identification sensor, a radio frequency identification (RFID) tag sensor, a motion sensor, a sound sensor, a vision sensor, a touch sensor, a temperature sensor, a humidity sensor, a light sensor, a pressure sensor, a gravity sensor, an acceleration sensor, and a bio-sensor.

9. The apparatus of claim 1, wherein the sensed data comprises software data collected through at least one of an electronic calendar application, a scheduler application, an e-mail management application, a message management application, a communication application, a social network application, and a web site management application.

10. The apparatus of claim 1, wherein the user input data is data received through at least one of a text input means, a graphic user interface (GUI), and a touch screen.

11. The apparatus of claim 1, wherein the user input data is data received through an input means for at least one of voice recognition, facial expression recognition, emotion recognition, gesture recognition, motion recognition, posture recognition, and multimodal recognition.

12. The apparatus of claim 1, further comprising:
a knowledge model database configured to store and maintain a knowledge model with respect to at least one domain knowledge; and
an intent model database configured to store and maintain an intent model that contains the user intent to use the interface.

13. The apparatus of claim 12, wherein the user intents are recognizable from the user context using at least one of search, logical inference, and pattern recognition.

14. The apparatus of claim 13, wherein the goal predicting unit is further configured to predict the user goal using the knowledge model or the intent model, based on the recognized current user context.

15. A method of providing a predictive goal interface, the method comprising:
recognizing a current user context by analyzing data sensed from a user environment condition and analyzing user input data received from the user;
analyzing a predictive goal based on the recognized current user context; and
providing a predictive goal interface comprising the analyzed predictive goal.

16. The method of claim 15, wherein the analyzing of the predictive goal analyzes the sensed data and the user input data, and analyzes the predictive goal that is retrievable from interface data stored in an interface database.

17. The method of claim 15, wherein the predicting goal analyzes at least one of profile information of the user, preference of the user, and user pattern information, which are stored in the user model database.

18. The method of claim 15, wherein the providing the predictive goal comprises providing the predictive goal when a confidence level of the predictive goal is greater than or equal to a threshold, the confidence level being based on the recognized current user context, and the method further comprises outputting the predictive goal interface comprising the provided predictive goal.

19. A non-transitory computer readable storage medium storing a program to implement a method of providing a predictive goal interface, comprising instructions to cause a computer to:
recognize a current user context by analyzing data sensed from a user environment condition and analyzing user input data received from the user;
analyze a predictive goal based on the recognized current user context; and
provide a predictive goal interface comprising the analyzed predictive goal.
